(19) United States
(12) Patent Application Publication
(10) Pub. No.: US 2015/0211976 A1
(43) Pub. Date: Jul. 30, 2015

(54) METHODS AND APPARATUS TO DETERMINE WORKPIECE CONTAMINATION

(71) Applicant: DÜRR ECOCLEAN GMBH, Filderstadt (DE)

(72) Inventors: Hermann-Josef David, Monschau (DE); Egon Käske, Aachen (DE)

(21) Appl. No.: 14/682,793

(22) Filed: Apr. 9, 2015

Related U.S. Application Data
(63) Continuation-in-part of application No. PCT/EP2013/071104, filed on Oct. 9, 2013.

(30) Foreign Application Priority Data
Oct. 10, 2012 (DE) 10 2012 218 489.9

(51) Int. Cl. G01N 15/06; B08B 3/14; H04N 5/33; G01N 21/35; H04N 5/225; B01D 39/08; G01N 21/17

(52) U.S. Cl. CPC G01N 15/0625; B01D 39/083; B08B 3/14; G01N 21/17; G01N 21/35; H04N 5/2256; H04N 5/33; B01D 2239/06; G01N 2021/1765

(57) ABSTRACT

Methods and apparatus to determine workpiece contamination are disclosed. One disclosed example apparatus includes a filter membrane to capture dirt particles from a characteristic volume, where the dirt particles are introduced to the liquid volume by subjecting the workpiece to the liquid volume. The example apparatus also includes a transporting device to move a portion of the filter membrane or a sensor relative to the portion. The example apparatus also includes an analysis computer to determine, based on the sensor, a dirt particle load of the liquid volume, where the dirt particle load is based on one or more of a type, a number, a size, or a size distribution of dirt particles accumulated on a section of the filter membrane.

### RELATED APPLICATIONS

This patent arises as a continuation-in-part of International Patent Application No. PCT/EP2013/071104, which was filed on Oct. 9, 2013, which claims priority to German Patent Application No. 10 2012 218 489, which was filed on Oct. 10, 2012. The foregoing International Patent Application and German Patent Application are hereby incorporated herein by reference in their entireties.

### FIELD OF THE DISCLOSURE

This disclosure relates generally to workpiece contamination, and, more particularly, to methods and apparatus to determine workpiece contamination.

### BACKGROUND

Contamination (e.g., soiling) such as dirt particles (e.g., particular chip material, dust, casting sand, salt residues, liquid droplets, etc.) can impair the function of industrially produced products, such as injection nozzles for internal combustion engines or oil ducts in crankcases for internal combustion engines, for example. The cleanness of workpieces in industrial production processes is, thus, of great importance. Therefore, in industrial production installations, the cleanness, cleanliness, soiling and/or contamination of workpieces has to be systematically checked regularly. Checking the cleanness or soiling is important particularly before intermediate and final assembly operations involving workpieces that are sensitive to dirt.

### BRIEF DESCRIPTION OF THE DRAWINGS

FIG. 1 shows a cleaning installation with a number of cleaning stations with an analysis system to analyze the contamination of workpieces and with a control computer.

FIG. 2 shows a section of the analysis system for analyzing the contamination of workpieces with a filter station.

FIG. 3 shows a perspective view of the filter station.

FIG. 4 shows a partial section of the filter station of FIG. 3.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to determine workpiece contamination are disclosed. The examples disclosed herein relate to an analysis system for determining (e.g., a means for determining) the contamination of a workpiece using a device that captures, on a filter membrane, dirt particles taken up in a characteristic liquid volume that are introduced into a liquid by subjecting the workpiece to the liquid and using a system to analyze the dirt particle load of the liquid that has been captured by the filter membrane.

The examples disclosed herein also relate to a cleaning installation for the cleaning of workpieces, which includes an analysis system for determining the contamination (e.g., a means for determining the contamination, etc.) of a workpiece, and to a method for cleaning workpieces in a cleaning installation.

WO 2012/045582 A1, which is hereby incorporated by reference in its entirety, discloses an analysis system for determining the soiling of workpieces in which a workpiece can be rinsed with a fluid to infer a degree of contamination of the workpiece based on a dirt particle load in this fluid.

An object of the examples disclosed herein is to provide a means to determine the contamination (e.g., soiling) of workpieces that may be integrated in a cleaning installation for workpieces and provides measured variables that allow monitoring and open-loop and/or closed-loop control of the cleaning installation.

This object may be achieved by determining the soiling of a workpiece of the type mentioned above in which the system for analyzing has an example analysis system (e.g., an analyzing means) connected to a computer unit, where a flat filter membrane has the shape of a displaceable band (e.g., a band form, a band section, etc.), which can be moved, at least sectionally, in relation to the analyzing system by a transporting device, and where the computer unit is connected to the analyzing system serves for determining a dirt-particle measured variable, M, in the form of the type, number, size and/or size distribution of dirt particles accumulated on the section of the filter membrane.

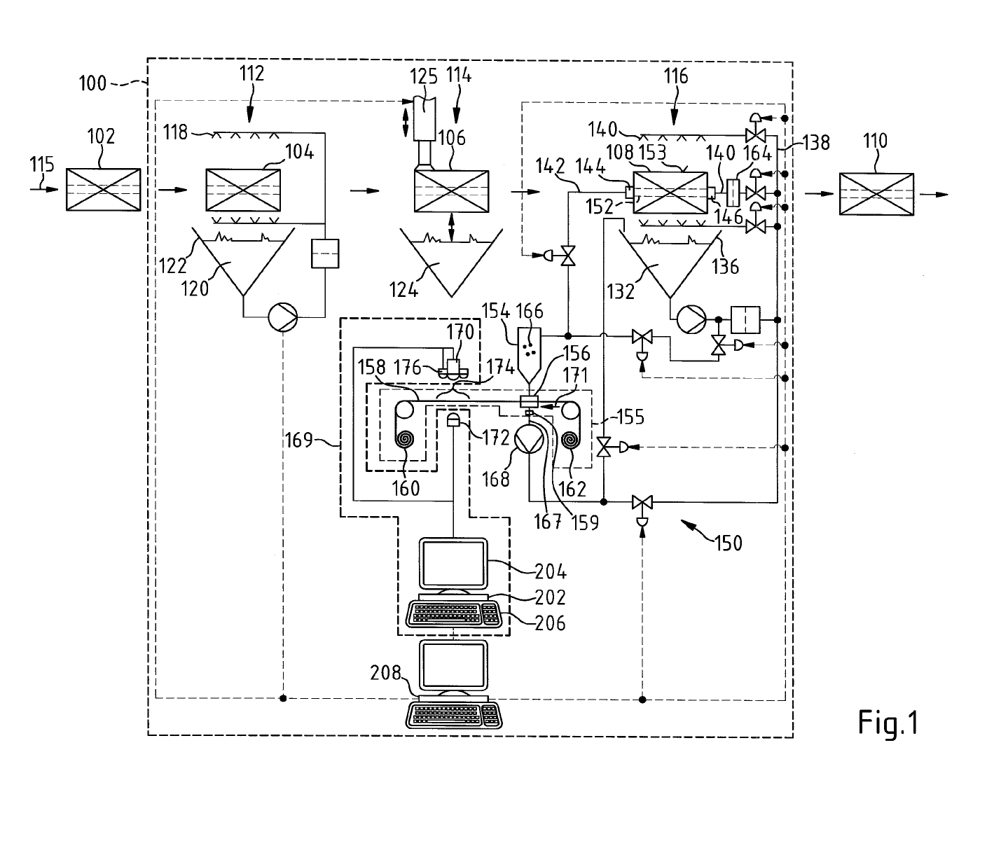

As set forth herein, an example cleaning installation 100 shown in FIG. 1 is integrated in a production line to produce items such as, for example, a production line to produce internal combustion engines for use in a motor vehicle. To clean workpieces 102, 104, 106, 108, 110, the installation 100 of the illustrated example has example cleaning stations or cleaning sections 112, 114, 116. In the cleaning stations or cleaning sections 112, 114, 116, the workpieces can be cleaned with a liquid cleaning fluid, such as, for example, water provided with cleaning additives. In the installation 100 of the illustrated example, there is an example conveying device 107, with which the workpieces 102, 104, 106, 108, 110 can be automatically moved through the cleaning stations 112, 114, 116 in a direction generally indicated by arrows 115. In the example cleaning station 112, spray nozzles 118 are positioned.

The spray nozzles 118 of the illustrated example are a cleaning system (e.g., cleaning means) to subject the workpiece 104 positioned in the cleaning station 112 to cleaning fluid 120. In this example, there is an example collecting container 122 for the cleaning fluid 120. During the cleaning of the workpiece 104, the dirt particles rinsed off the workpiece 104 by the cleaning fluid flow together with the cleaning fluid 120 into the collecting container 122. In this example, the cleaning station 114 has an example immersion bath 124, in which a workpiece 106 can be moved by a manipulating device (e.g., manipulating means) 125. A workpiece 108 in the cleaning station 116 can be cleaned with cleaning) fluid in the form of cleaning liquid 132, which is passed from a collecting container 136, through a system of lines 138, and to spray nozzles 140, via an example circulating pump 134.

The example installation 100 includes a stationary or mobile system (e.g., stationary or mobile means) 150 to determine the contamination (e.g., soiling, dirtiness, etc.) of a workpiece 108 before it is cleaned in the cleaning station 116. In the mobile system 150, both the soiling of a surface 153 of the workpiece 108 and the soiling in a section 152 inside the workpiece 108 can be determined. The section 152 of the workpiece 108 may be, for example, an oil duct in a crankcase of an internal combustion engine. For this purpose, the mobile system 150 may be connected via a line branch 141, 142 to the section 152 of the workpiece 108 by adapter pieces 144, 146, for example.

In this example, the workpiece 108 is clamped between the adapter pieces 144, 146 in such a way as to obtain in the line branch 141, 142, a sealed connection between the line and the workpiece 108, through which the cleaning fluid 132 is provided and then removed.

The system 150 of the illustrated example has a buffer container 154, which communicates with the system of lines 138. The buffer container 154 is connected to a filter station 156 of a device 155 for capturing a dirt particle load taken up in a fluid volume, through which a filter membrane band 158 is movably passed. For this purpose, the filter membrane band 158 is unwound from a band roller 162 while rolling up onto a driven band roller 160 that acts as a transporting device.

In an alternative example of the cleaning installation, the filter membrane band 158 may have a continuous configuration. For example, after an analysis of the dirt particle load taken up, the filter membrane band 158 may then undergo a cleaning step in the device 155, in the regions with dirt particles, and then used again to capture a dirt particle load in the cleaning installation.

Consequently, the system 150 is capable of automatically determining a basic contamination (e.g., the blind value) on the basis of a dirt particle load inherent to the lines and the cleaning liquid carried therein. If the measured blind value does not correspond to the predetermined values, the rinsing process is repeated (e.g., without the workpiece) until the blind value is reached.

In order to analyze the contamination (e.g., soiling) of the section 152 of the workpiece 108, it is rinsed for a defined time interval, Δt, in a rinsing operation with a cleaning liquid, which is freed of dirt particles in a filter device 164 positioned in the line branch 141.

When the filtered cleaning fluid 132 flows through the section 152 of the workpiece 108, the filtered cleaning fluid 132 takes up dirt particles 166, which are carried through the buffer container 154 to the filter station 156. In this example, the dirt particles 166 are retained on a section of the filter membrane band that is passed through by the cleaning fluid 132 in the filter station 156 when their grain size is greater than the microscopic through-openings of the filter membrane band 158. It should be noted that, according to the examples disclosed herein, in the cleaning installation the filter fineness or the filter efficiency is set for the filter membrane band in such a way that, as far as possible, only the dirt particle load that is deemed to be relevant to contamination (e.g., soiling) is captured by the filter membrane.

In order to return the cleaning fluid 132 that has passed through the filter membrane band 158 into the collecting container 136, in the system 150 there is a suction pump 168, which takes up the cleaning fluid 132 from the filter membrane 158 through a suction line 167. It should be noted in this connection that, in a modified example, the system 150 may also have a fluid circuit that is separate from the fluid circuit of a cleaning station in the cleaning installation 100.

The system 150 comprises an example system 169 for analyzing a dirt particle load that has been taken up by the filter membrane band 158 in the filter station. The system 169 of the illustrated example has a camera 170. With the camera 170 having an appropriate lens, the dirt particles deposited on the workpiece in the rinsing operation can be digitally recorded, in which the filter membrane band 158 with the dirt particles taken up in the filter station 156 is moved under the camera 170 in a direction generally indicated by an arrow 171. The camera 170 of the illustrated example includes an image sensor and an imaging lens and acts as a microscope and allows a magnifying, analyzable visualization of the dirt particles on the filter membrane band 158. The camera 170 of the illustrated example is assigned a first illuminating system (e.g., a first illuminating means) 172, with which a transmitted-light illumination can be set for a section 174 of the filter membrane band on which dirt particles are located. In the example system 169, there is also a second illuminating system (e.g., a second illuminating means) 176, which allows the setting of an incident-light illumination for the section 174 of the filter membrane band 158. Additionally or alternatively, the illuminating system 176 may be designed for a dark-field illumination setting for the section 174 of the filter membrane band 158. A dark-field illumination of the section 174 is understood, in this example, as meaning an illumination in which the illuminating light radiates onto the section 174 in a way that the camera 170 does not record through its objective lens any illuminating light that is reflected directly by the filter membrane 158 and dirt particles positioned on the filter membrane 158, but only receives illuminating light that is diffracted at the filter membrane band 158 and dirt particles accumulated thereon.

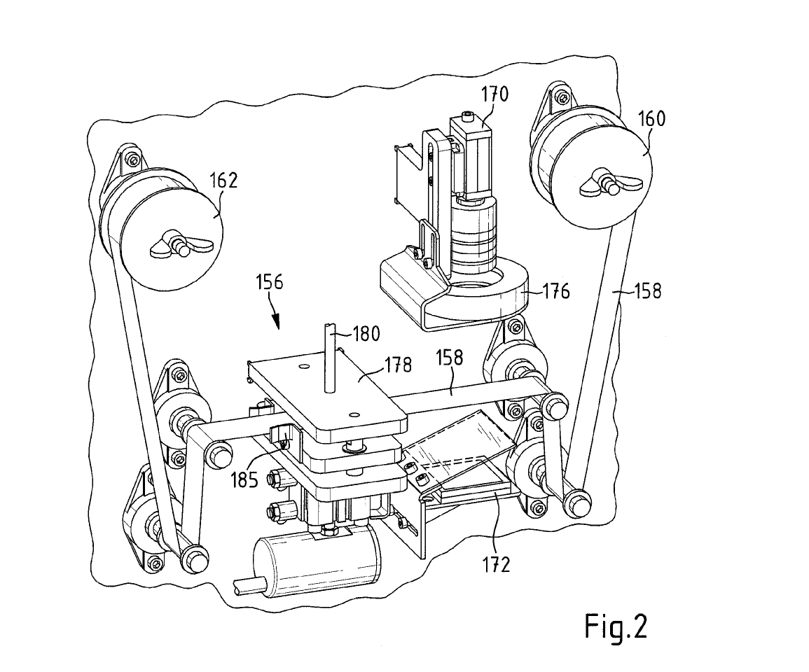

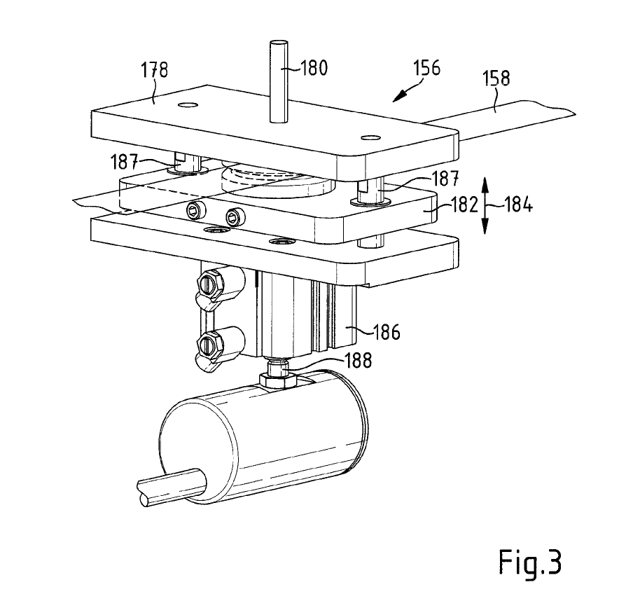

FIG. 2 shows a section of the means 150 for determining the contamination/soiling of workpieces or workpiece sections with the filter station 156. The filter station 156 of the illustrated example has a main body 178 with a feeding duct 180, which communicates with the buffer container 154. FIG. 3 is a perspective view of the filter station 156. In this example, the filter station 156 has a displaceably arranged opposing body 182, which can be moved relative to the main body 178 in a linear guiding system (e.g., a linear guiding means) 187 in a direction generally indicated by a double-headed arrow 184 by a driving system (e.g., a driving means) 186 having a hollow-shaft cylinder. In this example, the filter membrane band 158 is guided by a guiding system (e.g., a guiding means) 185 between the main body 178 and the opposing body 182.

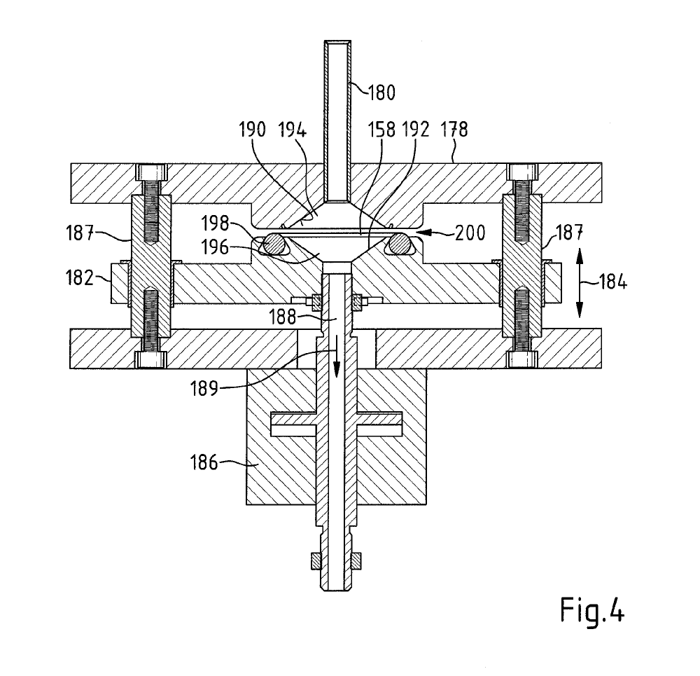

As can be seen in the illustrated example of FIG. 4, the main body 178 has a funnel-shaped recess 190. In this example, the opposing body 182 has a funnel-shaped recess 192. By displacing the opposing body in a direction generally indicated by the double-headed arrow 184, the opposing body 182 can be placed against the main body 178 to define a filter chamber, which is divided by the filter membrane band 158 into a section 194 on the main body side and a section 196 on the opposing body side. Because the opposing body 182 of the illustrated example is moved with respect to the main body 178 in the direction of the double-headed arrow 184, the filter chamber can be optionally opened and closed. The opposing body 182 has a discharging duct 188 for discharging fluid 132 that has passed through a region of the filter membrane band 158 in a direction generally indicated by the arrow 189.

During the analysis, the filter membrane band 158 may be clogged by cleaning liquid 132 that is heavily laden with dirt load. The suction pressure of the suction line 167 is monitored by a pressure sensor 159 connected to the computer unit 202. This allows determinations and/or conclusions concerning the state and the loading of the filter membrane 158 to be reached by a computer program stored in the computer unit 202, for example.

The funnel-shaped recess 192 of the opposing body 182 is surrounded by an O-ring 198, which acts as a sealing system (e.g., a sealing means) and laterally seals off the filter chamber when the opposing body 182 is lying against the main body 178.

In a modified example, the main body 178 and the opposing body 182 have a form-fitting sealing seating on their mutually contacting surfaces such as, for example, a round planar seating, conical seating or annular seating, whereby the filter membrane band 158 is held and securely clamped and the filter chamber 194, 196 is positioned. In this example, the filter member band 158 itself acts as a seal.

When the filter chamber is open, the filter membrane band of the illustrated example lies with the side facing away from the main body 178 against the opposing body 182. In this example, the filter membrane band 158 is separated from the main body 178 in the filter station 156 by an air gap 200 so that dirt particles that have been deposited from the cleaning fluid 132 on the filter membrane band 158 in an operation of rinsing the section 152 of the workpiece 108 are not stripped off the main body 178 on the way to the camera 170 when the filter membrane band 158 is displaced by rotating the band rollers 160, 162.

The camera 170 of the illustrated example is coupled to a computer unit 202. In this example, the computer unit 202 is assigned a display device, which is a monitor 204 in this example. The computer unit 202 of the illustrated example controls the camera 170, the lens of the camera and the illuminating systems 172, 176. In this example, for each operation of rinsing a workpiece 108, the computer unit 202 initiates the digital recording of the dirt particles on the filter membrane band 158, having been separated out in the filter station 156, with a transmitted-light illumination and an incident-light and/or dark-field illumination.

The computer unit 202 of the illustrated example includes a computer program for the image processing. With this computer program, the computer unit 202 determines from one or more images recorded with transmitted-light illumination a dirt-particle measured variable, M, in the form of the type, number, size and/or size distribution of dirt particles 166 accumulated on the section 174 of the filter membrane 158, having been separated out on the filter membrane band 158 in a rinsing operation in the filter station 156. Alternatively or additionally, with use of this computer program, the computer unit 202 may also determine, based on one or more recordings that have been made in incident-light and/or dark-field illumination, an integral value, I, for the image brightness as a dirt-particle measured variable, M.

In this example, the computer unit 202 then compares the determined dirt-particle measured variable, M, with a threshold value, S, entered via an input interface 206.

If the determined dirt-particle measured variable M exceeds the threshold value S, a display of the image of the filter membrane band 158 recorded with incident-light and/or transmitted-light illumination on the monitor 204 is initiated by the computer unit 202 and, for this purpose, the integral value, I, for the image brightness is additionally displayed as a dirt-particle radiance value, for example.

It should be noted that, in a modified, alternative example of the cleaning installation 100, the illuminating system 176 may also be equipped with various light sources or a combination of various light sources from the group consisting of light sources for generating daylight-like light, light sources for generating ultraviolet light, and light sources for generating infrared light, in particular for generating light flashes with wavelengths that lie in the infrared spectral range. Daylight systems, for example, are particularly well-suited for transmitted-light and incident-light analyses. In some examples, the sensitivity of the camera of the cleaning installation is adapted to the spectral range of the light generated by the light sources in an illuminating system. In some examples, with use of ultraviolet light, for example, organic substances, in particular, oil residues, for example, deposited on the filter membrane can be recorded particularly well. Using infrared light in connection with infrared cameras, for example, metal particles deposited on the filter membrane can be detected particularly well. Using an infrared flashlight, for example, heat pulses that bring about the rapid heating of metal particles can be generated. In the decaying phase, these particles can be detected for a long time and can be detected well with an infrared camera.

The filter membrane band 158 form of the cleaning installation 100 may be made of a fibrous woven fabric of polyethylene terephthalate (PET) or include a fibrous woven fabric that is based on the material PET or may include the material, PET.

In some examples, the thread density and fiber thickness in the fibrous woven fabric is selected to correspond to a filtering efficiency required for the filter membrane band (e.g., to correspond to the size of the dirt particles that the filter membrane is intended to hold back).

The filter membrane band 158 of the illustrated example is preferably coated and/or treated with chemical substances such as, for example, litmus. By detecting a discoloration of the filter membrane band, it is then possible to determine, for example, the pH of the cleaning fluid 132 in the cleaning station 116. To achieve this purpose, the type of discoloration is recorded with the camera system and evaluated in the computer unit 202 to infer the state of the cleaning fluid 132, for example.

It should additionally be mentioned that, in an alternative, modified example of the cleaning installation 100 to analyze dirt particles 166 accumulated on the filter membrane band 158, a magnet may be provided, and positioned under the filter membrane band 158, for example. Magnetizable, ferritic metal particles are then oriented by the magnetic field lines generated by the magnet, for example. In order to determine the number, size and/or size distribution of the ferritic metal particles accumulated on the filter membrane 158, the metal particles, in some examples, are recorded with a camera and the camera image then undergoes an image evaluation in the computer unit 202 to detect a characteristic orientation of the metal particles and analyze it in the computer unit 202.

In a further modified example of the cleaning installation 100, there may also be provided a computer unit 202, which includes a computer program for the image processing. With the computer program, the computer unit 202 determines from one or more images recorded with transmitted-light illumination, the particle size spectrum of the dirt particles separated out on the filter membrane band 158 in a rinsing operation of the filter station 156. In some examples, the particle size spectrum and the average particle size then yield further characteristic variables, which are used for determining an improved threshold value, S.

In a further modified example of the cleaning installation 100, it is envisaged to sweep over the surface of the filter membrane band 158 with a scanner, in particular with a laser scanner. By scanning the surface with a laser beam in a line or grid-like manner, a projected image of the filter surface geometry is then recorded and a dirt-particle measured variable, M, such as the size, the number and/or the size distribution of dirt particles accumulated on the filter membrane, is inferred from it by a computer program of a computer unit 202 connected to the laser scanner. This involves, for example, classifying every elevation on the filter membrane that is greater than the filter surface roughness as local soiling of the filter membrane.

It should be noted that in a modified example of the cleaning installation 100, there may also be provided a number of stationary and/or mobile system (e.g., mobile means) for determining the soiling of a section of a workpiece that are assigned to different cleaning stations in the cleaning installation, for example, and/or that serve to record the contamination of different sections of a workpiece. A mobile system is, for example, particularly well-suited for random sample investigations.

In some examples, it should additionally be noted that the system 150 for determining (e.g., means for determining) the soiling of a section of a workpiece 108 may also determine the number of dirt particles that are accumulated on the surface of the workpiece 108, in that the dirt particle load in a fluid volume with which the surface of the workpiece has been rinsed off is analyzed. It is also possible to analyze the number of accumulated dirt particles in a stream of fluid from a number of workpieces, to obtain a value of an average dirt load of a workpiece. In particular, in an alternative example, the system 150 for determining a workpiece soiling may also have a fluid circuit, which is separate from a circuit for cleaning liquid in a cleaning installation.

The example device 155 described above to capture a dirt particle load taken up in a fluid volume and the system 169 to analyze a dirt particle load and determine the contamination of a workpiece 108 may in principle also be used outside of a cleaning installation 100. They are, for example, also suitable for integration in a production or assembly line to implement an automatic cleanness analysis there, for example. In particular, an automatic cleanness analysis for a quality audit, for example. The cleanness analysis is especially meaningful in a production or assembly line where a pre-assembly or final assembly of workpieces takes place. This allows workpieces to be checked in a random sampling manner for a production process at regular intervals, for example, which allows an automatic batch log to be transmitted to a master computer in a production installation. With a cleanness analysis that is performed before the pre-assembly and final assembly of workpieces it may be ensured that few or no soiled workpieces are fitted. Consequently, the examples disclosed herein are also suitable for use in an assembly line for the pre-assembly or final assembly of complex systems that are made up of a number of components.

To control the cleaning processes for the workpieces 102, 104, 106, 108 in the cleaning sections or cleaning stations 112, 114, 116, the cleaning installation 100 includes a control computer 208. The control computer 208 of the illustrated example also controls the conveying system (e.g., the conveying means) for the workpieces in the cleaning installation 100 and allows the cleaning station 116 to be coupled to the system 150 for determining the soiling of a workpiece, and, thus, to determine the contamination of a workpiece. The cleaning processes for workpieces in the cleaning stations or cleaning sections 112, 114, 116 are controlled in that various cleaning parameters in the form of pump pressure, P, cleaning duration, Δt, and/or valve positions for controlling the flow of cleaning fluid are set.

The control computer 208 includes a computer program, which allows automatic setting of the operating parameters for the cleaning station or cleaning sections 112, 114, 116 and ensures that the workpieces 102, 104, 106, 108, 110 that are cleaned in the cleaning installation 100 satisfy a predetermined cleanness criterion, for example.

This computer program of the illustrated example has a routine for determining the blind value, B, of the system 150 to record the contamination of a workpiece 108. To determine the blind value, B, of the system 150, the cleaning liquid is circulated in successive rinsing processes of the cleaning station 116 without a workpiece positioned therein.

In this example, the cleaning fluid is passed through a section of pipe positioned between the adapter pieces 144, 146. As far as possible, this section of pipe, preferably, has little or no contamination/soiling. Thus, the section of pipe consequently forms a reference for an uncontaminated workpiece. In this example, the dirt particles in the cleaning liquid that are circulated through the cleaning station or the cleaning section 116 of the system 150 are then separated at the filter membrane 158 for each and every rinsing process.

By analyzing and quantifying in the system 150 the amount of dirt particles that are entrained in a volume of cleaning liquid used in a rinsing process, the computer program of the control computer 208 then determines a value for the dirt particle load with respect to an individual rinsing process. If this value remains the same for successive rinsing processes without a workpiece arranged in the cleaning station, this value corresponds to the contamination inherent to each and every volume of cleaning liquid in the cleaning station or in the cleaning section 116 of the installation that the contamination cannot go below (e.g., a blind value).

In this example, to determine the cleaning parameters that are favorable for the cleaning of a workpiece in the cleaning installation 100, a workpiece to be cleaned of a series of similarly soiled workpieces, which are also to be cleaned, is moved through the cleaning installation 100. The workpiece is thereby cleaned in the cleaning stations or cleaning sections 112, 114, 116 of the cleaning installation 100 with predetermined cleaning parameters for a specific time period, Δt₁. Once each and every cleaning operation in a cleaning station 112, 114, 116 has been completed, the cleaning results in a residual contamination/soiling, R, of the corresponding workpiece is then analyzed in the cleaning station 116 by the systems 150 for determining the contamination of a workpiece 108. If this residual contamination, R, is greater than a threshold value, S, referring to a specific cleaning station, the cleaning operation is repeated in the cleaning station concerned for a defined further time period, Δt₂, and the cleaning result is checked once again in the cleaning station or the cleaning section 116 in the manner described above. In this example, the computer program of the control computer 208 determines, in this manner, a value for a favorable cleaning time Δt_{g}=ΣᵢΔₜᵢ for the cleaning stations of the cleaning installation 100, and, consequently, cleaning parameters that ensure that a certain residual contamination, R, is not exceeded during the cleaning of workpieces.

In some examples, when successive workpieces from a series of workpieces are cleaned in the cleaning installation 100, after the completion of the cleaning operation, a measurement of the residual contamination, R, of the workpiece is carried out in the cleaning station or the cleaning section 116 by, the system 150 (e.g., a trend analysis). In some examples, if the computer program of the control computer 208 establishes that the residual contamination thereby recorded exceeds a threshold value, S, the cleaning time, Δt, of the cleaning of the workpieces in the cleaning stations 112, 114, 116 is correspondingly increased in the cleaning installation 100. In other examples, it is also possible, in some examples, that the computer program then emits, via the control computer, a warning signal to an operator of the cleaning installation 100.

In summary, the following preferred features of the examples disclosed herein should be noted as in the following. The examples disclosed herein relate to a system 150 to determine the contamination of a workpiece 108. In some examples, the system 150 includes a device 155 to capture dirt particles on a filter membrane 158 that are taken up in a characteristic liquid volume and that are introduced into a liquid by subjecting the workpiece 108 to the liquid. In this example, the system 150 includes a system (e.g., a means) 169 to analyze the dirt particle load from the liquid that has been captured by the filter membrane 158. The system 169 of the illustrated example for analyzing has an analyzing system (e.g., an analyzing means) 170 connected to a computer unit 202, in which the flat filter membrane 158 takes the form of a band and can be moved at least sectionally relative to the analyzing system 170 by a transporting device 160. The example computer unit 202, which is connected to the analyzing system 170, determines a dirt-particle measured variable, M, in the form of the type, number, size and/or size distribution of dirt particles 166 accumulated on the section 174 of the filter membrane 158.

An object of the examples disclosed herein is to provide a system (e.g., a means) to determine the contamination (e.g., soiling) of workpieces that may be integrated in a cleaning installation for workpieces and provides measured variables that allow monitoring and open-loop and/or closed-loop control of the cleaning installation.

This object may be achieved by determining the soiling of a workpiece of the type mentioned above in which the system for analyzing has an example analyzing system (e.g., an analyzing means) connected to a computer unit, where a flat filter membrane has the shape of a displaceable band (e.g., a band form, a band section, etc.), which can be moved, at least sectionally, in relation to the analyzing system by a transporting device, and where the computer unit is connected to the analyzing system serves for determining a dirt-particle measured variable, M, in the form of the type and/or number and/or size and/or size distribution of dirt particles accumulated on the section of the filter membrane.

To analyze the dirt particles captured on the filter membrane, the analyzing system may include a scanner, which records a profile of the surface of the filter membrane with dirt particles deposited on it, preferably by scanning via a laser beam, for example. An example computer unit connected to the scanner can be used to infer, based on the scanning signal of the scanner, a number, size and/or size distribution of dirt particles accumulated on the filter membrane.

The analyzing system preferably has a camera for the optical recording of a section of the filter membrane with dirt particles arranged on it, in which the computer unit determines the dirt-particle measured variable, M, by image processing.

The computer unit is in this case designed for comparing the determined dirt-particle measured variable, M, with a predeterminable threshold value, S, and is connected to a visualizing device. This allows for example an image of the section of the filter membrane recorded with incident-light illumination and/or dark-field illumination to be displayed to an operator of a cleaning installation the visualizing device if the determined dirt-particle measured variable, M, for dirt particles accumulated on the section of the filter membrane exceeds the predeterminable threshold value, S.

The system includes a first illuminating system (e.g., a first illuminating means) for providing a transmitted-light illumination for the section of the filter membrane that can be recorded with the camera and has a second illuminating system (e.g., a second illuminating means) for providing an incident-light illumination and/or a dark-field illumination for the section of the filter membrane that can be recorded with the camera. The computer unit can then calculate, for example, an integral brightness value, I, from at least one image of a section of the filter membrane band recorded with the camera under incident-light illumination to later display this value as a degree of radiance of a dirt particle load accumulated on the section.

The camera, preferably, has a lens, which records a section of the filter membrane with a suitable magnification. The illuminating system in the analysis system may be equipped here with various light sources, depending on the aim of the analysis.

Another concept of the examples disclosed herein is that the computer unit compares the determined dirt-particle measured variable, M, such as, for example, the number of dirt particles, the determined size of the dirt particles and/or the determined size distribution, with a reference, for example, a threshold value, S, or a reference distribution. The computer unit may then for example also display an image of the corresponding section of the filter membrane recorded with incident-light illumination and/or dark-field illumination on a visualizing device if the determined number of dirt particles, the determined size of the dirt particles, and/or the determined size of the dirt particles on the section of the filter membrane band, exceeds the reference, for example the threshold value, or the determined size distribution deviates from the reference distribution.

The band of the filter membrane may be a continuous filter band. Here it is of advantage if the analysis system comprises a device for removing a dirt particle load accumulated on the continuous filter band after the analysis in the system.

In order to move the filter membrane band continuously, a transporting device is provided in the analysis system.

The filter membrane may be produced, for example, from a woven fabric of polyethylene terephthalate (PET). In such examples, the filter membrane has, as far as possible, a filter fineness adapted to a desired analysis, and is preferably coated with further auxiliary substances such as, for example, litmus, and/or treated with one or more auxiliary substances.

The system for analyzing the dirt particle load captured by the filter membrane may also include a device for aligning magnetizable dirt particles arranged on the filter membrane by generating a magnetic field.

Because the filter membrane is coated, at least sectionally, with a substance that changes a physical and/or chemical property when it comes into contact with liquid to which the workpiece is subjected, the property being dependent on the chemical composition of the liquid, in particular, the pH of the liquid, for example, enables monitoring of the consistency of the liquid to which a workpiece is subjected.

The example device to capture a dirt particle load taken up in a fluid volume in a system (e.g., a means) in accordance with the teachings of this disclosure that may include an example filter station, through which the filter membrane band is passed to collect dirt particles. The filter station has, in this example, a main body with a feeding duct to supply fluid containing dirt particles and has an opposing body, which may be placed against the main body and, when the opposing body is placed against the main body, defines an example filter chamber by a recess formed in the main body and/or in the opposing body. The example filter chamber is divided by the flat filter membrane into a section on the main body side and a section on the opposing body side. The filter chamber can, in this example, be optionally opened and closed by moving the opposing body and the main body relative to one another. The opposing body then has a discharging duct, connected to a suction line, for the suction removal of fluid out of the filter chamber through the filter membrane. In this example, the device preferably includes a pressure sensor to record a suction pressure, P, of the suction line that is dependent on the amount of dirt particle load deposited on the filter membrane.

To achieve the effect that the fluid volume passed through the filter station can be subjected to a static pressure, in some examples, it is favorable if the recess formed in the main body and/or the opposing body is substantially sealed and is, for example, surrounded by a sealing system (e.g., a sealing means), which seals off the filter chamber when the opposing body contacts the main body. The sealing effect may be achieved by a form-fitting sealing seating, for example or by a sealing system (e.g., a sealing means), such as an O-ring, for example.

According to the examples disclosed herein, when the filter chamber is open, the flat filter membrane, preferably band-shaped (e.g., in band form), contacts the opposing body and is then separated from the main body by an air gap. This measure ensures that no dirt particles in the filter station have accumulated on the side facing the main body are stripped off when the filter membrane in band form is displaced.

According to the examples disclosed herein, the system for determining the contamination of a workpiece may be formed both as a stationary system and as a mobile system that can be displaced in production, for example, to investigate contamination of workpieces in an industrial production process from random samples.

The device to capture a dirt particle load taken up in a fluid volume may be integrated in a cleaning installation with at least one cleaning station, which includes a system for determining an initial contamination of a specific number of workpieces, of a single workpiece or of a section of a workpiece that are supplied to the cleaning station and/or are for determining a residual contamination of a specific number of workpieces, of a single workpiece or of a section of a workpiece that has been cleaned in the cleaning station, for example.

A cleaning installation according to the examples disclosed herein has at least one cleaning station and includes a system for determining (e.g., a means for determining) a contamination (e.g., soiling) of a workpiece that is supplied to the cleaning station. One concept of the examples disclosed herein is providing a computer unit in the cleaning installation, in which the computer unit includes a computer program for automatically determining a blind value, B, of the dirt particles taken up in a characteristic fluid volume of an accumulated fluid volume of liquid.

Some examples also extend to a method for setting the operating parameters, Δt, of a cleaning station in a cleaning installation. In such examples, the cleaning parameters may be set in dependence on a determined blind value, B, of a system (e.g., a means) for determining the contamination of a workpiece and, alternatively, in dependence of a residual contamination/soiling, R, of a cleaned workpiece that is recorded by the means for determining the contamination of the workpiece.

Consequently, the systems according to the examples disclosed herein makes it possible, for example, to produce a trend analysis of the cleanness values or residual contamination values of workpieces over relatively long time periods in a cleaning installation. This allows statements to be made concerning the operating state of the cleaning installation and the state of filters for the cleaning liquid that are used in the cleaning installation, for example.

For example, the examples disclosed herein propose, for the cleaning of workpieces in a cleaning installation, continuously recording the residual contamination, R, of the workpieces after the cleaning and increasing the cleaning time for the workpieces supplied to the cleaning installation in one or more cleaning stations of the cleaning installation and/or emitting a warning signal if the residual contamination, R, recorded for a cleaned workpiece exceeds a threshold value, S.

As set forth in accordance with the teachings of this disclosure, a means 150 for determining the soiling of a workpiece 108 includes a device 155 for capturing on a filter membrane 158 dirt particles taken up in a characteristic liquid volume that are introduced into a liquid by subjecting the workpiece 108 to the liquid, and a system 169 for analyzing the dirt particle load from the liquid that has been captured by the filter membrane 158. The system 169 for analyzing has an analyzing means 170 connected to a computer unit 202, where the flat filter membrane 158 takes the form of a displaceable band, which can be moved at least sectionally in relation to the analyzing means 170 by means of a transporting device 160, and where the computer unit 202 connected to the analyzing means 170 serves for determining a dirt-particle measured variable, M, in the form of the type, number, size and/or size distribution for dirt particles 166 accumulated on a section 174 of the filter membrane 158.

In some examples, the analyzing means includes a scanner, which records a profile of the surface of the filter membrane 158 with dirt particles 166 deposited on it by scanning with a laser beam. Some examples include illuminating means having light sources for generating infrared light which is passed to dirt-particles 166 arranged on the filter membrane 158, where the analyzing means includes at least one infrared camera for detecting metallic dirt-particles 166 which are exposed to the infrared light. In some examples, the illuminating means is designed for providing infrared light flashes in order to generate heat pulses impinging on the dirt-particles 166 arranged on the filter membrane 158.

In some examples, the computer unit 202 is designed for comparing the determined dirt-particle measured variable, M, with a predeterminable threshold value, S, and is connected to a visualizing device 204 to display an image of the section 174 of the filter membrane 158 if the determined dirt-particle measured variable, M, for dirt particles accumulated on the section 174 of the filter membrane 158 exceeds the predeterminable threshold value, S. In some examples, the analyzing means being adapted for the optical recording of a section 174 of the filter membrane 158 with the camera using incident-light illumination and/or dark-field illumination. Some examples include a first illuminating means 172 for providing a transmitted-light illumination for the section 174 of the filter membrane 158 that can be recorded with the camera 170 and a second illuminating means 176 for providing an incident-light illumination and/or a dark-field illumination for the section 174 of the filter membrane 158 that can be recorded with the camera 170.

In some examples, for calculating an integral brightness value, I, the computer unit 202 calculates from at least one image of a section 174 of the filter membrane 158 in band form recorded with the camera 170 under incident-light illumination an integral brightness value, I, to display this value as a degree of radiance of a dirt particle load accumulated on the section 174. In some examples, the band of the filter membrane 158 is a continuous filter band and a device for removing a dirt particle load accumulated on the continuous filter band after the analysis in the system 169 is provided. In some examples, the filter membrane 158 is a PET woven fabric. In some examples, the system 169 for analyzing the dirt particle load that has been captured by the filter membrane 158 includes a device for orienting magnetizable dirt particles arranged on the filter membrane 158 by generating magnetic field lines.

In some examples, the device 155 for capturing a dirt particle load taken up in a fluid volume includes a filter station 156, through which the filter membrane 158 in band form is passed for taking up dirt particles 166, where the filter station 156 has a main body 178 with a feeding duct 180 for supplying fluid laden with dirt particles and has an opposing body 182, which can be placed against the main body 178 and, when the opposing body 182 is placed against the main body 178, defines a filter chamber by a recess 190, 192 formed in the main body 178 and/or in the opposing body 182, which chamber is divided by the flat filter membrane 158 into a section on the main body side and a section on the opposing body side, where the filter chamber can be optionally opened and closed by moving the opposing body 182 and the main body 178 in relation to one another, where the opposing body 182 has a discharging duct 188, connected to a suction line 167, for the suction removal of fluid out of the filter chamber through the filter membrane 158, and where a pressure sensor 159 is provided for recording a suction pressure, P, in the suction line 167 that is dependent on the amount of dirt particle load deposited on the filter membrane 158.

An example cleaning installation 100 includes at least one cleaning station 116 and with a means 150, formed in particular as described in one of those mentioned above, for determining a soiling of a workpiece 108 that is supplied to the cleaning station 116. Some examples include a computer unit 208, which includes a computer program for automatically determining a blind value, B, of the means 150 for determining a soiling of a workpiece 108 by way of the dirt particles inherently taken up in a characteristic fluid volume of the liquid.

One example method for setting at least one operating parameter, Δt, for at least one cleaning station 116 in a cleaning installation 100 as described above, in which the at least one operating parameter, Δt, is determined in dependence on a determined blind value, B, of the means 150 for determining a soiling of a workpiece 108 and in dependence on a residual soiling, R, of a cleaned workpiece 108 that is recorded by the means 150 in a computer unit 208 and is output to the at least one cleaning station 116 for the setting of the operating parameter, Δt. In some examples, the residual soiling, R, of the workpieces 108 is continuously recorded in the means 150 after the cleaning and the cleaning time, Δt, for the workpieces 108 supplied to the cleaning installation 100 is increased and/or a warning signal, W, is emitted if the residual soiling, R, recorded for a cleaned workpiece exceeds a threshold value, S.

An example apparatus includes a filter membrane to capture dirt particles from a characteristic volume, where the dirt particles are introduced to the liquid volume by subjecting the workpiece to the liquid volume. The example apparatus also includes a transporting device to move a portion of the filter membrane or a sensor relative to the portion. The example apparatus also includes an analysis computer to determine, based on the sensor, a dirt particle load of the liquid volume, where the dirt particle load is based on one or more of a type, a number, a size, or a size distribution of dirt particles accumulated on a section of the filter membrane.

An example method includes capturing dirt particles on a filter membrane, where the dirt particles are from a characteristic liquid volume introduced into the liquid volume by subjecting the workpiece to the liquid volume. The example method also includes moving a band of the filter membrane or a sensor relative to the band, and determining, using a processor and based on the sensor, a dirt particle load of the liquid volume, where the dirt particle load of the liquid volume is based on one or more of a type, a number, a size, or a size distribution of dirt particles accumulated on a section of the filter membrane.

An example means 150 for determining the soiling of a workpiece 108 includes a device 155 for capturing on a filter membrane 158 dirt particles taken up in a characteristic liquid volume that are introduced into a liquid by subjecting the workpiece 108 to the liquid, and a system 169 for analyzing the dirt particle load from the liquid that has been captured by the filter membrane 158. the system 169 for analyzing has an analyzing means 170 connected to a computer unit 202, where the flat filter membrane 158 takes the form of a displaceable band, which can be moved at least sectionally in relation to the analyzing means 170 by means of a transporting device 160, and where the computer unit 202 connected to the analyzing means 170 serves for determining a dirt-particle measured variable, M, in the form of the type, number, size and/or size distribution for dirt particles 166 accumulated on a section 174 of the filter membrane 158.

In some examples, the analyzing means includes a scanner, which records a profile of the surface of the filter membrane 158 with dirt particles 166 deposited on it by scanning with a laser beam. In some examples, the analyzing means has a camera 170 for the optical recording of a section 174 of the filter membrane 158 with dirt particles 166 arranged on it and the computer unit 202 determines the dirt-particle measured variable, M, by means of image processing. In some examples, the computer unit 202 is designed for comparing the determined dirt-particle measured variable, M, with a predeterminable threshold value, S, and is connected to a visualizing device 204 in order to display an image of the section 174 of the filter membrane 158 recorded, in particular, with incident-light illumination and/or dark-field illumination if the determined dirt-particle measured variable, M, for dirt particles accumulated on the section 174 of the filter membrane 158 exceeds the predeterminable threshold value, S.

Some examples include a first illuminating means 172 for providing a transmitted-light illumination for the section 174 of the filter membrane 158 that can be recorded with the camera 170 and a second illuminating means 176 for providing an incident-light illumination and/or a dark-field illumination for the section 174 of the filter membrane 15) that can be recorded with the camera 170. In some examples, for calculating an integral brightness value, I, the computer unit 202 calculates from at least one image of a section 174 of the filter membrane 158 in band form recorded with the camera 170 under incident-light illumination an integral brightness value, I, in order to display this value as a degree of radiance of a dirt particle load accumulated on the section 174. In some examples, the band of the filter membrane 158 is a continuous filter band and a device for removing a dirt particle load accumulated on the continuous filter band after the analysis in the system 169 is provided. In some examples, the filter membrane 158 is a PET woven fabric. In some examples, the system 169 for analyzing the dirt particle load that has been captured by the filter membrane 158 includes a device for orienting magnetizable dirt particles arranged on the filter membrane 158 by generating magnetic field lines. In some examples, the filter membrane 158 is coated at least sectionally with a substance that changes a physical and/or chemical property when it comes into contact with liquid to which the workpiece 108 is subjected, the property being dependent on the chemical composition of the liquid, in particular dependent on the pH of the liquid.

In some examples, the device 155 for capturing a dirt particle load taken up in a fluid volume includes a filter station 156, through which the filter membrane 158 in band form is passed for taking up dirt particles 166, where the filter station 156 has a main body 178 with a feeding duct 180 for supplying fluid laden with dirt particles and has an opposing body 182, which can be placed against the main body 178 and, when the opposing body 182 is placed against the main body 178, defines a filter chamber by a recess 190, 192 formed in the main body 178 and/or in the opposing body 182, which chamber is divided by the flat filter membrane 158 into a section on the main body side and a section on the opposing body side, where the filter chamber can be optionally opened and closed by moving the opposing body 182 and the main body 178 in relation to one another, in which the opposing body 182 has a discharging duct 188, connected to a suction line 167, for the suction removal of fluid out of the filter chamber through the filter membrane 158, and where a pressure sensor 159 is provided for recording a suction pressure, P, in the suction line 167 that is dependent on the amount of dirt particle load deposited on the filter membrane 158.

An example cleaning installation includes a means 150, formed in particular as described above, for determining a soiling of a workpiece 108 that is supplied to the cleaning station 116. Some examples include a computer unit 208, which includes a computer program for automatically determining a blind value, B, of the means 150 for determining a soiling of a workpiece 108 by way of the dirt particles inherently taken up in a characteristic fluid volume of the liquid.

An example method for setting at least one operating parameter, Δt, has at least one cleaning station 116 in a cleaning installation 100 as described above, in which the at least one operating parameter, Δt, is determined in dependence on a determined blind value, B, of the means 150 for determining a soiling of a workpiece 108 and in dependence on a residual soiling, R of a cleaned workpiece 108 that is recorded by the means 150 in a computer unit 208 and is output to the at least one cleaning station 116 for the setting of the operating parameter, Δt. An example method for cleaning workpieces in a cleaning installation 100 formed as described above, in which the residual soiling, R, of the workpieces 108 is continuously recorded in the means 150 after the cleaning and the cleaning time, Δt, for the workpieces 108 supplied to the cleaning installation 100 is increased and/or a warning signal, W, is emitted if the residual soiling, R, recorded for a cleaned workpiece exceeds a threshold value, S.

From the foregoing, it will be appreciated that the above disclosed methods and apparatus enable a way to determine contamination/soiling of workpieces and using measured variables that allow effective monitoring and/or closed loop control of a cleaning installation.

This patent arises as a continuation-in-part of International Patent Application No. PCT/EP2013/071104, which was filed on Oct. 9, 2013, which claims priority to German Patent Application No. 10 2012 218 489, which was filed on Oct. 10, 2012. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A system for determining the contamination of a workpiece, comprising:
a device to capture dirt particles on a filter membrane, the dirt particles from a characteristic liquid volume and introduced into a liquid by subjecting the workpiece to the liquid; and
a system to analyze a dirt particle load from the liquid that has been captured by the filter membrane,
wherein the system to analyze the dirt particle load comprises an analyzing system coupled to a computer unit, wherein the flat filter membrane takes the form of a displaceable band, which can be moved sectionally in relation to the analyzing system by a transporting device, and wherein the computer unit is coupled to the analyzing system, the analyzing system is to determine a dirt-particle measured variable, M, in the form of one or more of a type, a number, a size, or a size distribution of dirt particles accumulated on a section of the filter membrane.

2. The system as defined in claim 1, wherein the analyzing system comprises a scanner, which records a profile of the surface of the filter membrane with dirt particles deposited on it by scanning with a laser beam.

3. The system as defined in claim 1, wherein the analyzing system comprises a camera for the optical recording of a section of the filter membrane with dirt particles positioned thereon and the computer unit determines the dirt-particle measured variable, M, by image processing.

4. The system as defined in claim 3, further comprising an illuminating system comprises light sources to generate infrared light towards dirt-particles positioned on the filter membrane, the analyzing system including at least one infrared camera for detecting metallic dirt-particles that are exposed to the infrared light.

5. The system as defined in claim 4, wherein the illuminating system is to provide infrared light flashes to generate heat pulses impinging on the dirt-particles positioned on the filter membrane.

6. The system as defined in claim 3, wherein the computer unit is to compare the determined dirt-particle measured variable, M, with a predeterminable threshold value, S, and is coupled to a visualizing device to display an image of the section of the filter membrane if the determined dirt-particle measured variable, M, for dirt particles accumulated on the section of the filter membrane exceeds the predeterminable threshold value, S.

7. The system as defined in claim 6, wherein the analyzing system is adapted for the optical recording of a section of the filter membrane by the camera using incident-light illumination and/or dark-field illumination.

8. The system as defined in claim 3, further comprising a first illuminating system for providing a transmitted-light illumination for the section of the filter membrane that can be recorded with the camera and a second illuminating system for providing an incident-light illumination and/or a dark-field illumination for the section of the filter membrane that can be recorded with the camera.

9. The system as defined in claim 3, wherein in calculating an integral brightness value, I, the computer unit calculates from at least one image of a section of the filter membrane in band form recorded with the camera under incident-light illumination, an integral brightness value, I, to display this value as a degree of radiance of a dirt particle load accumulated on the section.

10. The system as defined in claim 2, wherein the filter membrane is a continuous filter band and a device for removing a dirt particle load accumulated on the continuous filter band after the analysis in the system is provided.

11. The system as defined in claim 1, wherein the filter membrane is a PET woven fabric.

12. The system as defined in claim 1, wherein the system for analyzing the dirt particle load that has been captured by the filter membrane comprises a device for orienting magnetizable dirt particles arranged on the filter membrane by generating magnetic field lines.

13. The system as defined in claim 1, wherein the filter membrane is coated, at least sectionally, with a substance that changes a physical and/or chemical property when brought into contact with liquid to which the workpiece is subjected, the property being dependent on the chemical composition of the liquid.

14. The system as defined in claim 1, wherein the device to capture a dirt particle load taken up in a fluid volume comprises a filter station, through which the filter membrane band is passed to take up dirt particles, wherein the filter station comprises a main body with a feeding duct for supplying fluid laden with dirt particles and an opposing body, which can be placed against the main body and, when the opposing body is placed against the main body, defines a filter chamber by a recess formed in the main body and/or in the opposing body, which chamber is divided by the flat filter membrane into a section on the main body side and a section on the opposing body side, wherein the filter chamber can be optionally opened and closed by moving the opposing body and the main body in relation to one another, wherein the opposing body comprises a discharging duct, connected to a suction line, for the suction removal of fluid out of the filter chamber through the filter membrane, and wherein a pressure sensor is provided for recording a suction pressure, P, in the suction line that is dependent on the amount of dirt particle load deposited on the filter membrane.

15. A cleaning installation comprising at least one cleaning station and with a system, formed in particular as defined in claim 1, for determining a soiling of a workpiece that is supplied to the cleaning station.

16. The cleaning installation as defined in claim 15, wherein a computer unit, which comprises a computer program to automatically determine a blind value, B, of the system for determining a soiling of a workpiece based on the dirt particles inherently taken up in a characteristic fluid volume of the liquid.

17. A method for setting at least one operating parameter, Δt, for at least one cleaning station in a cleaning installation as defined in claim 15, in which the at least one operating parameter, Δt, is determined in dependence on a determined blind value, B, of the system for determining a soiling of a workpiece and in dependence on a residual soiling, R, of a cleaned workpiece 108 that is recorded by the system in a computer unit and is output to the at least one cleaning station for the setting of the operating parameter, Δt.

18. A method for cleaning workpieces in a cleaning installation as defined in claim 15, wherein the residual soiling, R, of the workpieces is continuously recorded in the system after the cleaning and the cleaning time, Δt, for the workpieces supplied to the cleaning installation is increased and/or a warning signal, W, is emitted if the residual soiling, R, recorded for a cleaned workpiece exceeds a threshold value, S.

19. An apparatus comprising:
a filter membrane to capture dirt particles from a characteristic liquid volume, the dirt particles introduced to the liquid volume by subjecting the workpiece to the liquid volume;
a transporting device to move a portion of the filter membrane or a sensor relative to the portion; and
an analysis computer to determine, based on the sensor, a dirt particle load of the liquid volume, the dirt particle load based on one or more of a type, a number, a size, or a size distribution of dirt particles accumulated on a section of the filter membrane.

20. A method comprising:
capturing dirt particles on a filter membrane, the dirt particles from a characteristic liquid volume introduced into the liquid volume by subjecting the workpiece to the liquid volume;
moving a band of the filter membrane or a sensor relative to the band; and
determining, using a processor and based on the sensor, a dirt particle load of the liquid volume, the dirt particle load of the liquid volume based on one or more of a type, a number, a size, or a size distribution of dirt particles accumulated on a section of the filter membrane.
